(19) United States
(12) Patent Application Publication
(10) Pub. No.: US 2014/0270755 A1
(43) Pub. Date: Sep. 18, 2014

(54) METHODS AND APPARATUSES FOR IMPROVED ETHERNET PATH SELECTION USING OPTICAL LEVELS

(71) Applicant: Hubbell Incorporated, Shelton, CT (US)

(72) Inventors: Peter Bradley Schmitz, Fairfax Station, VA (US); Mark Christopher Orton, Falls Church, VA (US)

(73) Assignee: Hubbell Incorporated, Shelton, CT (US)

(21) Appl. No.: 14/044,044

(22) Filed: Oct. 2, 2013

Related U.S. Application Data
(60) Provisional application No. 61/782,442, filed on Mar. 14, 2013.

(51) Int. Cl. H04B 10/079

(52) U.S. Cl. CPC H04B 10/0795
USPC 398/26

(57) ABSTRACT

Methods and apparatuses are provided to employ an enhanced Loss of Signal (ELOS) function in network equipment (NE) such as an Ethernet switch that is coupled to an optical path by a transceiver (e.g., an SFP). Diagnostics such as optical path receive (Rx) level from the transceiver are used by the ELOS function to regenerate LOS status from the transceiver when either LOS or designated low Rx level conditions exist. By generating an enhanced LOS (ELOS) on a designated low Rx level, the ELOS function ensures a failing data path is removed before an undesirable amount of errors occur to enhance Ethernet path selection and improve Carrier Ethernet quality of service.

This application claims the benefit of U.S. provisional patent application Ser. No. 61/782,442, filed Mar. 14, 2013; the entire contents of which are incorporated by reference herein.

### BACKGROUND OF THE INVENTION

1. Field of the Invention

The present invention relates to a method and apparatus for providing enhanced Ethernet path selection using optical levels.

2. Description of Related Art

Telcos or large carriers such as AT&T and Verizon, which can provide telecommunications and data communications services to customers throughout large geographic areas, are increasingly using Ethernet but still support significant SONET infrastructure. Telcos want to provide Carrier Ethernet with the same quality of service (QoS) as SONET QoS. Unlike service providers for Enterprise Ethernet networks (e.g., in buildings, and on campuses), these telcos or larger carriers are accustomed to using SONET metrics such as bit error rate (BER) of SONET payload for path degradation detection. Unlike SONET, however, Ethernet transmission has no meaningful BER metric. For example, Ethernet packets vary significantly and, as such, their degradation or loss does not correlate accurately to a BER, yet packet loss can be significant. Further, unlike Enterprise Ethernet providers, telcos are required to guarantee a level of QoS to customers for SONET as well as any Ethernet service they provide. A need therefore exists for convenient employment of a more accurate QoS metric for larger carrier Ethernet transport.

For telcos or large carriers providing Carrier Ethernet, a need also exists for protection switching to occur as quickly as possible and with the lowest errors possible. For example, many fiber optic Ethernet devices that support redundant or aggregated data paths employ Loss of Signal (LOS) to indicate a failing data path and, accordingly, a need to switch to alternate data path(s). Existing Ethernet devices, however, are disadvantageous because excessive errors may occur on the failing data path before LOS occurs in the event of seriously degraded fiber optic performance.

Ethernet path selection can occur, for example, in the context of Ethernet Automatic Protection Switching (APS) (e.g., as defined in Recommendation ITU-T G.8031 for linear 1:1 or 1+1 protection switching mechanism for VLAN-based Ethernet networks). G.8031 supports 1:1 linear protection through implementation of point-to-point Ethernet Tunnels providing a working and protecting Ethernet circuit, where the path providing the protection is always available through health-monitoring.

Within each working and protecting Ethernet circuit or path, using fast Connectivity Check Messages (CCM) can provide an inherent fault detection mechanism as part of the protocol since they are used to verify basic service connectivity and health of data paths. Failure detection of a working path by such a mechanism can trigger a move from working to protecting circuits. Upon failure, re-convergence times are dependent on the failure detection mechanisms. For example, the CCM transmit interval can determine the response time. The OS supports message timers as low as 10 milliseconds so the restoration times are comparable to SONET/SDH. Alternatively, 802.3ah (Ethernet in the First Mile) or simple Loss of Signal can act as a trigger for a protection switch where appropriate.

If a failure of a link or node affects the working or primary Ethernet tunnel path, the services will fail to receive the CCMs exchanged on that path or will receive a fault indication (e.g., LOS) from the link layer OAM module. Network equipment (NE) declares connectivity failure when a designated number of consecutive CCMs (e.g., three) are lost. For example, when a path has degraded but has not completely failed, one in four CCMs may be received, leaving 75% of the data being possibly in error and with no alarm message or declaration of path failure. Thus, degraded path conditions continue to occur.

Further, a LOS signal is not generated or asserted until a designated optical level (e.g., −x dbm) parameter or condition is met. As with the absence of consecutive CCMs, an optical path can be operating under degraded conditions long before received optical signal level meets the designated level for asserting LOS.

A need therefore exists for a prompt mechanism for determining if an optical path has degraded. Also, a need exists for shortening the time interval between the detection or indication of possible Ethernet path degradation and the initiation of Ethernet path selection (e.g., switch protection). A need also exists for a method or apparatus that determines inadequate receive level in an Ethernet path and generates a LOS or other fault or alarm indication as early as possible after signal degradation commences (e.g., even before the designated level for asserting LOS in a particular SFP is met).

### SUMMARY OF THE INVENTION

The above and other problems are overcome, and additional advantages are realized by illustrative embodiments of the present invention.

In accordance with an illustrative embodiment of the present invention, an apparatus for and method of enhanced monitoring for optical signal level degradation is provided that: obtains at least one diagnostic level from a small form-factor pluggable (SFP) transceiver connected to an optical path, the diagnostic level comprising at least the designated level for asserting loss of signal (LOS) by the SFP transceiver; determines at least one parameter corresponding to a low receive level threshold for an optical path having a value that is above the SFP LOS assertion level by a designated amount; receives Rx level for the optical path from the transceiver; determines if the received Rx level satisfies the low receive level threshold; and asserts an enhanced (ELOS) when the received Rx level reaches the low receive level threshold.

In accordance with aspects of an illustrative embodiment of the present invention, the parameter is a margin designating a selected value above, at, or below a reference diagnostic level. For example, the margin can be a selected value relative to an alarm level. The method and apparatus can generate a prompt via a user interface for the user to enter a user-settable value for the parameter and store the user-settable value.

In accordance with others aspects of an illustrative embodiment of the present invention, the apparatus and method can store a parameter corresponding to a recovery threshold for the optical path, the recovery threshold being a value that is greater than the low receive level threshold. The apparatus and method also de-assert the Loss of Signal or other fault indication due to the received Rx level reaching the low receive level threshold when the received Rx level satisfies the recovery threshold.

In accordance with an illustrative embodiment of the present invention, the apparatus and method further perform a logical OR operation using the enhanced Loss of Signal (ELOS) generated when the received Rx level reaches the low receive level threshold, and a Loss of Signal provided by the SFP transceiver when the received Rx level reaches the SFP LOS assertion level.

The apparatus and method also transmit an output of the logical OR operation (e.g., an alarm or fault indication) to a network device in which the transceiver is deployed such that the network device can commence path selection to remove the degraded optical path.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

Aspects of the invention will be more readily understood with reference to the illustrative embodiments thereof illustrated in the attached drawing figures, in which:

FIG. 1 is a block diagram of an Ethernet network and network elements constructed in accordance with an illustrative embodiment of the present invention;

FIG. 2 is a block diagram of an enhanced Loss of Signal module in accordance with an illustrative embodiment of the present invention; and

FIG. 3 depicts a process flow for operation of an enhanced Loss of Signal module in accordance with an illustrative embodiment of the present invention.

Throughout the drawing figures, like reference numbers will be understood to refer to like elements, features and structures.

### DETAILED DESCRIPTION OF ILLUSTRATIVE EMBODIMENTS

In accordance with illustrative embodiments of the present invention and with reference to FIGS. 1 through 3, a system 8 for providing Ethernet services comprises network equipment (NE) comprising a far end (FE) device 12 and a near end (NE) device 10 connected to a fiber optic link indicated generally at 14. The fiber optic link 14 comprises multiple paths for redundancy or aggregation. The fiber optic link 14 can extend, for example, between any of a remote terminal (RT), Hut, CEV, building telephone room, or central office, and any of a cell site suite, building rooftop, or customer premise, as well as between NEs used for campus or intrabuilding connections, with the NEs 10,12 deployed (e.g., as a card or Network Interface Device (NID)) at one of these illustrative locations on respective ends of the fiber optic link 14.

With reference to FIG. 1, the NEs 10, 12 each employ at least two transceivers 16, 18 such as small form-factor pluggables (SFPs) 16a, 16b at NE 12 and SFPs 18a, 18b at NE 10. In accordance with an illustrative embodiment of the present invention, an enhanced Loss of Signal module (ELOS) 20 is provided in each NE 10, 12 and is described below. For illustrative purposes, only two transceivers are shown per NE, but it is to be understood that NEs can comprise more than two transceivers.

The transceivers 16, 18 are SFPs for illustrative purposes. A small form-factor pluggable (SFP) is a compact, hot-pluggable transceiver used for both telecommunication and data communications applications. The form factor and electrical interface are specified by a multi-source agreement (MSA) and standardized by the SFF Committee (e.g., in the SFP specification INF-8074i available at ftp://ftp.seagate.com/sff/INF-8074.pdf), and is incorporated by reference herein in its entirety. An SFP is plugged into communication devices, such as switches and routers or similar network equipment (NE), to provide a media conversion, such as converting electrical signals to optical signals for transport over fiber optics. For example, an SFP transceiver interfaces a network device motherboard (e.g., for a switch, router, media converter or similar network equipment) to a fiber optic or copper networking cable. SFP transceivers are designed to support SONET, Gigabit Ethernet, Fibre Channel, and other communications standards and have been used for data rates of 1 Gbit/s to 5 Gbit/s.

It is to be understood that the devices 10, 12 can employ other commercially available form-factor pluggable transceivers which operate at higher rates or lower rates than SFPs. For example, the form-factor pluggable transceivers 16, 18 can be, but are not limited to, a gigabit interface converter (GBIC), SFP+, 10 gigabit (G) SFP (XFP), a Quad SFP (QSFP) supporting 10 G per channel (i.e., 40 G), a centum (C) or CFP transceiver (e.g., supports 10×10 Gbit/s and 4×25 Gbit/s variants of 100 Gbit/s interconnects), Xenpack module, or a dongle, among other transceiver devices.

The form-factor pluggable transceivers 16, 18 have built-in diagnostic capabilities to determine and output receive (Rx) level information relating to optical input power to its host device 10, 12. Provision of the Rx level information is specified, for example, by the above-mentioned multi-source agreement (MSA) and standardized by the SFF Committee. See, for example, the specification INF-8074i available at ftp://ftp.seagate.com/sff/INF-8074.pdf and the specification SFF-8472 available at ftp://ftp.seagate.com/sff/SFF-8472.PDF, and any other SFF Committee documents or similar specifications for SFPs or other types of transceivers. The MSA defines the presence, location, and format of the Rx level information, and then individual SFP manufacturers determine, for example, the values per SFP device that are provisioned or otherwise configured in the devices. For example, such values as Rx sensitivity level, Rx Alarm and Warning levels, and Rx LOS assert and de-assert levels can be designated by an SFP manufacturer based on performance characteristics of the SFP (e.g., rate, wavelength), and stored on the SFP. These SFP values can be read from the SFP by a host device. As described herein in accordance with illustrative embodiments of the present invention, these values can be used to determine the appropriate Rx thresholds to assert or de-assert an enhanced LOS or otherwise provide an alarm or warning before conventional conditions that precipitate a conventional LOS occur.

In accordance with illustrative embodiments of the present invention, the NEs 10 and 12 are each provided with an enhanced loss of signal (ELOS) module 20 which may be implemented in hardware and/or software. For example, software comprising an instruction set can be downloaded to a memory in the NE 10, 12, or a programmable gate array (e.g., an FPGA), programmable integrated circuit (IC) (e.g., a microprocessor, or microcontroller), or other processing device that cooperates with the NE's processor can be provided to the NE (e.g., as a pluggable unit to or otherwise mounted on the NE printed circuit board). The ELOS module 20 comprises a memory or cooperates with a memory device of the NE processor to store parameters such as margins for deriving thresholds relative to optical input power (e.g., Rx level) conditions that contribute to the generation or assertion of a Loss of Signal (LOS) by the NE 10,12 or removal or de-assertion of LOS after recovery. It is to be understood that the margin can be a positive value or negative value relative to a selected alarm or warning level, or zero (i.e., margin=‘0’) when the parameter is assigned, for example, to be the same as a designated diagnostic alarm or warning level.

In accordance with an illustrative embodiment of the present invention, a NE ELOS module 20 receives the Rx level information from a transceiver 16, 18 in the NE 10, 12, analyzes the Rx level information using the stored parameters such as margins described below relating to optical input power conditions, and generates a system LOS if an optical input power condition is met. Accordingly, the ELOS module 20 operates to regenerate the LOS status from the transceiver (e.g., SFP module 16, 18) such that an LOS can be forwarded to the NE 10,12 when either SFP LOS or designated Rx Low level condition exists. The present invention is advantageous because it allows forcing LOS on a low Rx level, thereby insuring a failing data path is removed before an undesirable amount of errors occur, and possibly before any errors occur.

Reference is now made to FIG. 2, which depicts an ELOS module 20 in accordance with an illustrative embodiment of the present invention. The ELOS module 20 is deployed at an NE 10, 12 (not shown) and comprises a serial link 32 to a transceiver (e.g., an SFP 16 or 18) from which it receives the Rx level information, as well as the receive alarm signal level and warning signal level for that SFP, for example, among any other diagnostic data. The ELOS module 20 is configured with an Rx Level Alarm Monitor function 22 that analyzes the Rx level information (e.g., using the above-described stored margins relating to optical input power) to determine if conditions or thresholds are met and, if so, generate an Rx Low signal 24 that triggers a Loss of Signal (LOS). For example, the ELOS module 20 can store (1) a selected margin (dB) with respect to the alarm level of an SFP, which can be used to derive the Rx Low indication threshold at which the Rx Low signal 24 is generated or asserted by the ELOS module 20; and (2) a selected margin (dB) with respect to the warning level of the SFP, which can be used to derive the Recovery threshold (e.g., at which the Rx Low signal 24 is removed or de-asserted). It is to be understood that the ELOS module 20 can assert and de-assert the Rx Low signal 24 at other thresholds or levels, or relative to other diagnostic levels used as a reference (e.g., Alarm, Warning, or both). For example, since Rx Alarm and Warning levels (e.g., 5 dB and 2 dB below Rx sensitivity) specified by an SFP manufacturer provide information about when the received optical signal is no longer reliable, the ELOS module 20 can apply a margin (e.g., a positive margin, a negative margin, or a margin=0) to one or more of these levels to determine new ELOS assertion and de-assertion levels that are different from conventional LOS assertion and de-assertion levels (e.g., on the order of 13 dB below Rx sensitivity for LOS assertion and the Rx sensitivity level for LOS de-assertion). Thus, the ELOS module 20 can assert an early or enhanced LOS in response to detected deterioration of the received optical power before the deterioration reaches the conditions required (e.g., 13 dB below Rx sensitivity) for a conventional LOS to be asserted. Correspondingly, the ELOS module 20 can de-assert an early or enhanced LOS even if the received optical power is still below the RX sensitivity level. In any event, in accordance with advantageous aspects of the present invention, the Rx Low indication threshold and the Recovery threshold can be relative (e.g., above, below or at) to one or more diagnostic levels used as a reference(s), but are different from the conventional LOS and RX sensitivity levels, respectively.

As shown in FIG. 2, the Rx Level Alarm Monitor function 22 compares the Rx level received from the SFP (e.g., via the serial link 32) with the Rx Low indication threshold and, if the Rx level has been determined to have degraded to the Rx Low indication threshold, the Rx Level Alarm Monitor function 22 generates a “Rx Low” output indicated at 24. The Rx Level Alarm Monitor function 22 employs logic (e.g., an OR gate 26) to generate a System LOS 30 whenever it receives an Rx Low output 24 (e.g., an enhanced LOS in accordance with illustrative embodiments of the present invention) or an SFP LOS 28. The ELOS module 20 allows NEs 10, 12 to use SFP diagnostics (e.g., Rx Level via link 32) and a Rx Low indication threshold that is higher than the LOS level designated by the corresponding SFP to generate an Rx Low output upon detection of signal degradation and/or condition(s) contributing to signal degradation that occurs earlier than conditions meeting the LOS threshold of the SFP. The NEs 10, 12 can therefore perform earlier and possibly pre-emptive Ethernet path selection to minimize errors when an optical path degrades.

In an example implementation, the ELOS module 20 is provided as a set of program instructions and parameters to a programmed processor (e.g., a ColdFire® microprocessor) in a NE 10, 12 such as an Ethernet switching system. The ELOS module 20 is able to receive an SFP LOS 34, and receive and interpret diagnostic data from the SFP (e.g., Rx Level via link 32) and, depending on the Rx Level relative to the Rx Low indication threshold, generate or assert a LOS indication 30 independently of that received from the physical circuit (e.g., SFP LOS 34). The NE 10, 12, in turn, receives a fault output 30 (e.g., System LOS) from the ELOS module 20. Correspondingly, the ELOS module 20 is able to receive and interpret diagnostic data from the SFP (e.g., Rx Level via link 32) and, depending on the Rx Level relative to the Recovery threshold, de-assert the LOS indication 30.

The ELOS module 20 can also be configured, for example, as part of the programmed control of an Ethernet switch IC or be a separate electronic component that operates in conjunction with the Ethernet switch IC. The ELOS module 20 can also be configured as program code and parameters stored on a computer-readable memory accessed by the NE. Whatever the configuration, the ELOS module 20 operates in conjunction with a transceiver and NE 10, 12 to monitor Rx level information and LOS from the transceiver and generate an indication of an alarm or fault condition that is derived from a Rx level when that Rx level meets the Rx Low indication threshold or when a SFP LOS 34 is received which can, in turn, result in the NE 10,12 commencing path selection operations such as switch protection.

Reference is now made to FIG. 3, which represents example operations of an ELOS module 20 in accordance with an illustrative embodiment of the present invention. As described in connection with FIG. 3, a processor can be a processor of an NE 10, 12 programmed in accordance with the ELOS module 20, or a separate processing device operating in conjunction with the NE processor.

As stated above, the above-described margins for deriving the Rx Low indication and Recovery thresholds for a given SFP (e.g., based on alarm and warning levels or Rx sensitivity level that can be read from the transceiver) can be designated by a user (block 50), such as by user-settable parameters on a Ethernet switch operating with an ELOS module 20, or pre-configured in a memory associated with the ELOS module 20. The processor receives an Rx level from the transceiver 16, 18 (e.g., via the serial link 32), as indicated at 52 in FIG. 3. As stated above, the processor can derive the Rx Low indication and Recovery thresholds and compare the received Rx level to them. If the Rx level is determined to meet the Rx Low indication threshold (e.g., a selected margin (dB) below Rx sensitivity level such as at the Alarm level for the SFP), then an Rx Low output 24 (e.g., an enhanced LOS in accordance with illustrative embodiments of the present invention) is generated as indicated at 60. The processor continues monitor Rx level information received via the serial link 32 (e.g., if the Rx Low indication threshold is not met, as indicated by the negative branch of block 58, and after an Rx Low output 24 is generated as indicated at 62). If the Rx level is determined to meet the Recovery threshold (e.g., a selected margin (dB) below Rx sensitivity level such as at the Warning level for the SFP) as indicated at 64, then the Rx Low output 24 is removed or terminated as indicated at 66.

The Rx level can be continuously or periodically monitored. Further, the condition determination can be done essentially continuously or periodically at designated intervals. Further, it is to be understood that the margin for the Rx Low indication threshold can be selected such that the Rx Low indication threshold is an Rx level at some value other than the SFP Alarm level. Similarly, the margin for the Recovery threshold can be selected such that the Recovery threshold is an Rx level at some value other than the SFP Warning level and above the Rx Low indication threshold. As stated above, the margin can be a positive value, a negative value or zero, such that the parameter is above, below or at a designated level (e.g., a diagnostic level) for the SFP, and that different SFP diagnostic levels can be used as reference levels with respect to the margin.

Thus, in accordance with an advantageous aspect of illustrative embodiments of the present invention, the NE 10, 12 with ELOS module 20 benefits from the diagnostic functionality of a small form factor pluggable (SFP) module or other transceiver that can provide a received optical signal level, which is a more valuable metric than BER for evaluating optical path degradation. Further, the use of an enhanced designated low level (e.g., as derived by a selected margin with respect to an alarm level of an SFP) by the ELOS module 20 to force an earlier LOS 30 allows earlier path degradation detection, earlier indication of LOS and therefore earlier switch protection to minimize errors due to optical path degradation.

As stated above, the ELOS module 20 can be provided to each of a near end NE 10 and a far end NE 12 that support at least two aggregated links (e.g., indicated generally at 14) to allow switching to one link when the other link is indicating signal degradation. The NE 10, 12 can be, for example, Carrier Ethernet units such as cards (e.g., a SuperG card available from Pulse Communications, Inc., Herndon, Va.) or Network Interface Devices (NIDs). As stated above, the advantages of the ELOS module are not limited to link aggregation.

Additional Illustrative Aspects of NE with Enhanced LOS Modules

The system 8 can be part of a service provider network and may represent a single communication service provider or multiple communications services providers. The service provider network can be, for example, a metro Ethernet network utilizing any number of topologies and including various nodes, entities, switches, servers, UNIs, CPE devices, NIDs, and other communication elements. Communications within the service provider network may occur on any number of networks which may include wireless networks, data or packet networks, cable networks, satellite networks, private networks, publicly switched telephone networks (PSTN), or other types of communication networks. The service provider's network is understood to be an infrastructure for sending and receiving data, messages, packets, and signals according to one or more designated formats, standards, and protocols.

The service provider may perform testing and management for a connection or link between the data network 8 and NE 10,12. In particular, the service provider may perform testing as implemented through the SFP transceiver 16, 18 or other conventional transceiver (e.g., XFP, QSFP, and so on) coupled to a NE. The service provider may measure frame loss, discarded traffic, throughput, and other traffic information between the transceiver, the NE and the link 14.

The NE 10, 12 and/or ELOS module 20 may include any number of computing and telecommunications components, devices, or elements which may include busses, motherboards, circuits, ports, interfaces, cards, connections, converters, adapters, transceivers, displays, antennas, and other similar components.

Illustrative embodiments of the present invention can be implemented, at least in part, in digital electronic circuitry, analog electronic circuitry, or in computer hardware, firmware, software, or in combinations of them. The components of the ELOS module 20 can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Illustrative embodiments of the present invention have been described with reference to a NE 10, 12 with ELOS module 20, among other components. It is to be understood, however, that the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion.

Also, functional programs, codes, and code segments for accomplishing the present invention can be easily construed as within the scope of the invention by programmers skilled in the art to which the present invention pertains.

Method steps, processes or operations associated with an ELOS module 20 can be performed by one or more programmable processors executing a computer program to perform functions of the invention by operating on input data and generating an output. Method steps can also be performed by, and an apparatus according to illustrative embodiments of the present invention, can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

While the invention herein disclosed has been described by means of specific embodiments and applications thereof, numerous modifications and variations can be made thereto by those skilled in the art without departing from the scope of the invention.

What is claimed is:

1. A method of enhanced monitoring for optical signal level degradation comprising:
obtaining at least one diagnostic level from a small form-factor pluggable (SFP) transceiver connected to an optical path, the diagnostic level comprising at least the designated loss of signal (LOS) assertion level of the SFP transceiver;
determining at least one parameter corresponding to a low receive level threshold for an optical path, the low receive level threshold having a value that is above the SFP LOS assertion level by a designated amount;
receiving Rx level for the optical path from the transceiver;
determining if the received Rx level satisfies the low receive level threshold; and
asserting an enhanced LOS (ELOS) when the received Rx level reaches the low receive level threshold.

2. The method of claim 1, further comprising selecting a diagnostic level of the SFP transceiver to be a reference level, wherein the parameter is a margin designating a selected value above, below, or at the reference diagnostic level.

3. The method of claim 2, further comprising designating the reference diagnostic level and the margin such that the low receive level threshold corresponds to an alarm level of the SFP transceiver.

4. The method of claim 2, wherein at least one of the reference diagnostic level and the parameter is user-settable.

5. The method of claim 1, wherein storing comprises storing a parameter corresponding to a recovery threshold for the optical path, the recovery threshold being a value that is greater than the low receive level threshold.

6. The method of claim 5, further comprising de-asserting the ELOS when the received Rx level satisfies the recovery threshold.

7. The method of claim 2, wherein:
the obtaining the at least one diagnostic level comprises obtaining the Rx sensitivity of the SFP transceiver;
the determining at least one parameter comprises
applying respective margins to the Rx sensitivity to generate values representing the low receive level threshold and a recovery threshold, respectively; and
storing the generated values; and
the determining comprises if the received Rx level satisfies the low receive level threshold or the recovery threshold, the ELOS being asserted when the received Rx level reaches the low receive level threshold and the ELOS being de-asserted when the received Rx level reaches the recovery threshold.

8. The method of claim 7, wherein the low receive level threshold is a value x dBm above the SFP LOS assertion level, and the recovery threshold is a value y dBm above the low receive level threshold, and y>x> SFP LOS assertion level of the SFP transceiver.

9. The method of claim 1, further comprising performing a logical OR operation using the enhanced Loss of Signal (ELOS) generated when the received Rx level reaches the low receive level threshold, and a Loss of Signal provided by the SFP transceiver when the received Rx level reaches the SFP LOS assertion level.

10. The method of claim 9, further comprising transmitting an output of the logical OR operation to provide a LOS, alarm or fault indication to a network device in which the SFP transceiver is deployed.

11. The method of claim 1, wherein storing the parameter further comprises storing the parameter in a memory device that is not integral to the SFP transceiver.

12. A non-transitory computer-readable medium storing a program for enhanced monitoring of optical signal level degradation comprising:
a first set of instructions for obtaining at least one diagnostic level from a small form-factor pluggable (SFP) transceiver connected to an optical path, the diagnostic level comprising at least the designated loss of signal (LOS) assertion level of the SFP transceiver;
a second set of instructions for determining at least one parameter corresponding to a low receive level threshold for an optical path, the low receive level threshold having a value that is above the SFP LOS assertion level by a designated amount;
a third set of instructions for receiving Rx level for the optical path from the transceiver and determining if the received Rx level satisfies the low receive level threshold; and
a fourth set of instructions for asserting an enhanced LOS (ELOS) when the received Rx level reaches the low receive level threshold.

13. The non-transitory computer-readable medium of claim 12, wherein
the first set of instructions comprises instructions for obtaining the Rx sensitivity of the SFP transceiver;
the second set of instructions comprises instructions for
storing a parameter corresponding to a recovery threshold for the optical path;
calculating values representing the low receive level threshold and a recovery threshold using respective margins with the Rx sensitivity; and
storing the calculated values; and
the third set of instructions comprises instructions for determining if the received Rx level satisfies the low receive level threshold or the recovery threshold, the ELOS being asserted when the received Rx level reaches the low receive level threshold and the ELOS being de-asserted when the received Rx level reaches the recovery threshold.

14. The non-transitory computer-readable medium of claim 13, wherein the low receive level threshold is a value x dBm above the SFP LOS assertion level, and the recovery threshold is a value y dBm above the low receive level threshold, and y>x> SFP LOS assertion level of the SFP transceiver.

15. The non-transitory computer-readable medium of claim 12, further comprising a fourth set of instructions for generating a prompt via a user interface for the user to enter a user-settable value for the parameter and storing the user-settable value.
